(19) United States
(12) Patent Application Publication
(10) Pub. No.: US 2026/0173193 A1
(43) Pub. Date: Jun. 18, 2026

(54) APPARATUS AND METHOD FOR OPERATING CONTROL MESSAGE IN WIRELESS COMMUNICATION SYSTEM

(71) Applicant: Electronics and Telecommunications Research Institute, Daejeon (KR)

(72) Inventors: Hyung Sub KIM, Daejeon (KR); Nam I KIM, Daejeon (KR); Jee Hyeon NA, Daejeon (KR); Dong Seok ROH, Daejeon (KR)

(73) Assignee: Electronics and Telecommunications Research Institute, Daejeon (KR)

(21) Appl. No.: 19/389,485

(22) Filed: Nov. 14, 2025

(30) Foreign Application Priority Data
Nov. 19, 2024 (KR) 10-2024-0164961

(51) Int. Cl. H04W 76/18; H04W 72/52; H04W 88/08

(52) U.S. Cl. CPC H04W 76/18; H04W 72/52; H04W 88/085

(57) ABSTRACT

An operating method for improving a transmission efficiency of an RRC (radio resource control) reject message in a wireless communication system includes receiving, in advance, information required to generate the RRC reject message needed when rejecting a connection request of a user equipment (UE) from a gNB-CU or an NG-eNB-CU, storing the information received in advance in a gNB-DU or an NG-eNB-DU, receiving, by the gNB-DU or the NG-eNB-DU, an uplink RRC packet data unit (PDU) from the UE, generating the RRC reject message based on the information stored in advance when the connection request from the UE is not accepted based on the RRC PDU, and terminating, by the gNB-DU or the NG-eNB-DU, a connection request procedure by directly transmitting the RRC reject message to the UE without passing through the gNB-CU or the NG-eNB-CU.

### CROSS-REFERENCE TO RELATED APPLICATIONS

This application claims priority under 35 U.S.C. § 119 to Korean Patent Application No. 10-2024-0164961 filed on Nov. 19, 2024, in the Korean Intellectual Property Office, the disclosures of which are incorporated by reference herein in their entireties.

### BACKGROUND

Embodiments of the present disclosure described herein relate to a wireless communication system, and more particularly, relate to an apparatus and a method for operating control messages in a wireless communication system.

In a 5G wireless communication system, a base station (BS) may be classified as a gNB (next generation Node B) newly defined in a 5G system, an NG-eNB (next generation-evolved Node B), which is an evolved form of a legacy 4G system, etc. Functional splitting may be applied to the gNB and the NG-eNB based on an interface (or a protocol stack) with a user equipment (UE).

The gNB and the NG-eNB to which functional splitting is applied may be divided into a gNB-CU (central unit) and a gNB-DU (distributed unit), and an NG-eNB-CU and an NG-eNB-DU, respectively, according to deployed protocol layers, and control-plane interfaces between the CU and the DU are defined as F1 application protocol (F1AP) and W1 application protocol (W1AP), respectively.

### SUMMARY

Embodiments of the present disclosure provide, based on the foregoing discussion, an apparatus and a method for operating control messages in a wireless communication system.

In addition, embodiments of the present disclosure provide an apparatus and a method for distinguishing and processing cell-level overload states in a wireless communication system.

In addition, embodiments of the present disclosure provide an apparatus and a method for efficiently transmitting a radio resource control (RRC) reject message (RRCReject) in a wireless communication system.

In addition, embodiments of the present disclosure provide an apparatus and a method for supporting optimized decision-making by gNB and NG-eNB control units through cell state management in a wireless communication system.

According to an embodiment of the present disclosure, an operating method for improving a transmission efficiency of an RRC (radio resource control) reject message in a wireless communication system includes receiving, in advance, information required to generate the RRC reject message needed when rejecting a connection request of a user equipment (UE) from a gNB-CU or an NG-eNB-CU, storing the information received in advance in a gNB-DU or an NG-eNB-DU, receiving, by the gNB-DU or the NG-eNB-DU, an uplink RRC packet data unit (PDU) from the UE, generating the RRC reject message based on the information stored in advance when the connection request from the UE is not accepted based on the RRC PDU, and terminating, by the gNB-DU or the NG-eNB-DU, a connection request procedure by directly transmitting the RRC reject message to the UE without passing through the gNB-CU or the NG-eNB-CU.

According to an embodiment of the present disclosure, a method for improving control message operation efficiency in a wireless communication system includes collecting cell state information including an overload state with respect to one or more cells managed by a gNB-DU or an NG-eNB-DU, transmitting the cell state information and a cell identifier for identifying each of the cells to a gNB-CU or an NG-eNB-CU, identifying, by the gNB-CU or the NG-eNB-CU, a cell having the overload state by analyzing the cell identifier and the cell state information received from the gNB-DU or the NG-eNB-DU, and performing, by the gNB-CU or the NG-eNB-CU, optimized resource allocation and control actions with respect to the cell identified as being in the overload state.

According to an embodiment of the present disclosure, an apparatus for improving transmission efficiency of an RRC (radio resource control) reject message in a wireless communication system includes a transceiver, and a processor operatively connected to the transceiver, and wherein the processor receives, in advance, information required to generate the RRC reject message needed when rejecting a connection request of a user equipment (UE) from a gNB-CU or an NG-eNB-CU, stores the information received in advance in a gNB-DU or an NG-eNB-DU, causes the gNB-DU or the NG-eNB-DU to receive an uplink RRC packet data unit (PDU) from the UE, generates the RRC reject message based on the information stored in advance when the connection request of the UE is not accepted based on the RRC PDU, and causes the gNB-DU or the NG-eNB-DU to directly transmit the RRC reject message to the UE without passing through the gNB-CU or the NG-eNB-CU, to terminate a connection request procedure.

According to an embodiment of the present disclosure, an apparatus for improving control message operation efficiency in a wireless communication system includes a transceiver, and a processor operatively connected to the transceiver, and the processor collects cell state information including an overload state with respect to one or more cells managed by a gNB-DU or an NG-eNB-DU, transmits the cell state information and a cell identifier identifying each of the cells to a gNB-CU or an NG-eNB-CU, causes the gNB-CU or the NG-eNB-CU to analyze the cell identifier and the cell state information received from the gNB-DU or the NG-eNB-DU, to identify a cell having the overload state, and causes the gNB-CU or the NG-eNB-CU to perform optimized resource allocation and control actions with respect to the cell identified as being in the overload state.

### BRIEF DESCRIPTION OF THE FIGURES

The above and other objects and features of the present disclosure will become apparent by describing in detail embodiments thereof with reference to the accompanying drawings.

FIG. 1 illustrates an example of a gNB structure according to functional splitting, according to various embodiments of the present disclosure.

FIG. 2 illustrates another example of a gNB structure according to functional splitting, according to various embodiments of the present disclosure.

FIG. 3 illustrates a signal flow for transferring an uplink common control channel (UL CCCH) radio resource control (RRC) message, according to one embodiment of the present disclosure.

FIG. 4 illustrates an example of an NG-eNB structure according to functional splitting, according to various embodiments of the present disclosure.

FIG. 5 illustrates another example of an NG-eNB structure according to functional splitting, according to various embodiments of the present disclosure.

FIG. 6 illustrates a configuration of a user equipment (UE) in a wireless communication system, according to various embodiments of the present disclosure.

FIG. 7 illustrates a configuration of a gNB including a central unit (CU) and a distributed unit (DU), according to various embodiments of the present disclosure.

### DETAILED DESCRIPTION

Terms used in the specification are used to describe specified embodiments of the present disclosure and may be not intended to limit the scope of other embodiments. Singular expressions may include plural expressions unless the context clearly indicates otherwise. All the terms used herein, which include technical or scientific terms, may have the same meaning as commonly understood by a person skilled in the art described in the present disclosure. Among the terms used in the present disclosure, terms defined in a general dictionary may be construed to have meanings that are the same as or similar to those understood in the context of the related art, and, unless explicitly defined in the present disclosure, shall not be interpreted in an idealized or overly formal sense. In some cases, even though terms are terms which are defined in the present disclosure, they may not be interpreted to exclude embodiments of the present disclosure.

In various embodiments of the present disclosure described below, a hardware-based approach is described by way of example. However, the various embodiments of the present disclosure include techniques that utilize both hardware and software, and thus, the various embodiments of the present disclosure do not exclude software-based approaches.

In addition, in the detailed description and the claims of the present disclosure, the phrase “at least one of A, B, and C” may mean “only A,” “only B,” “only C,” or “any combination of A, B, and C.” Further, the phrases “at least one of A, B, or C” or “at least one of A, B, and/or C” may be understood to have the same meaning as “at least one of A, B, and C.”

Hereinafter, the present disclosure relates to an apparatus and a method for operating control messages in a wireless communication system. In detail, the present disclosure describes a technique for optimizing network resource management and system performance by improving the efficiency of control message operation in a wireless communication system.

In the following description, terms referring to signals, terms referring to channels, terms referring to control information, terms referring to network entities, terms referring to components of an apparatus, and the like are illustrated for convenience of description. Accordingly, the present disclosure is not limited to the terms described below, and other terms having equivalent technical meanings may be used.

In addition, although various embodiments of the present disclosure are described using terms used in certain communication standards (e.g., 3GPP (3rd Generation Partnership Project)), this is merely for illustrative purposes. Various embodiments of the present disclosure may be readily modified and applied to other communication systems.

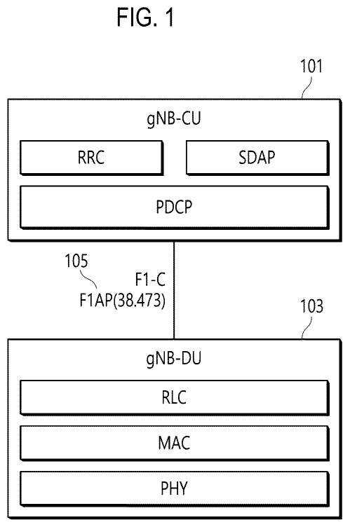

FIG. 1 illustrates an example of a gNB structure according to functional splitting, according to various embodiments of the present disclosure. In detail, FIG. 1 illustrates a structure of a gNB (next generation Node B) in a 5G network, and relates to functional splitting between a gNB-central unit (CU) and a gNB-distributed unit (DU).

Referring to FIG. 1, a gNB-CU 101 and a gNB-DU 103 are connected by an F1-C interface (F1 application protocol (F1AP)) 105.

The gNB-CU 101 may include a radio resource control (RRC) layer, a service data adaptation protocol (SDAP) layer, and a packet data convergence protocol (PDCP) layer. The RRC layer is responsible for control of radio resources and may manage procedures such as cell configuration, connection establishment, and handover. The SDAP layer may be responsible for quality of service (QoS) management of service data and mapping of service flows. The PDCP layer may perform functions for improving transmission efficiency, such as encryption, compression, and duplicate control of data packets.

The gNB-DU 103 may include a radio link control (RLC) layer, a medium access control (MAC) layer, and a physical (PHY) layer. The RLC layer may manage error correction, retransmission, and the like for reliable transmission of data links. The MAC layer may be responsible for scheduling radio resources and may serve as an interface with the physical layer. The PHY layer may be a physical layer responsible for transmission and reception of radio signals.

The F1-C interface (F1 application protocol (F1AP)) 105 may handle a control plane between the gNB-CU 101 and the gNB-DU 103, and may perform cell resource management, exchange of state information, and the like.

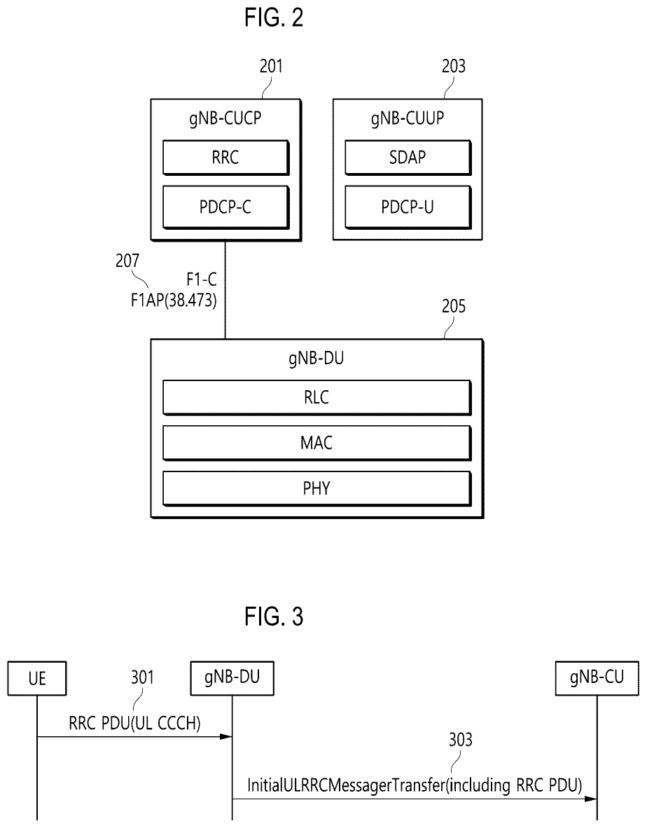

FIG. 2 illustrates another example of a gNB structure according to functional splitting, according to various embodiments of the present disclosure. In detail, FIG. 2 illustrates a functional split structure of a gNB in a 5G network. In FIG. 2, the gNB is divided into a gNB-central unit control plane (gNB-CUCP) 201, a gNB-central unit user plane (gNB-CUUP) 203, and a gNB-DU 205. Such a structure enables efficient network operation by separating control plane functions from user plane functions.

The gNB-CUCP 201 may include an RRC layer and a PDCP-C (packet data convergence protocol-control plane) layer. The RRC layer may perform the same role as the RRC described with reference to FIG. 1. The PDCP-C layer may handle control plane packet processing and may perform encryption, integrity protection, and the like.

The gNB-CUUP 203 may include an SDAP layer and a PDCP-U (packet data convergence protocol-user plane) layer. The SDAP layer may perform the same role as the SDAP layer described with reference to FIG. 1. The PDCP-U layer may process user plane data packets and may improve transmission efficiency through data compression, encryption, and the like.

The gNB-DU 205 may include an RLC layer, a MAC layer, and a PHY layer. The RLC layer, the MAC layer, and the PHY layer may perform the same functions as the RLC layer, the MAC layer, and the PHY layer described with reference to FIG. 1.

An F1-C interface (F1AP-control plane) 207 may handle control plane communication between the gNB-CUCP 201 and the gNB-DU 205, and may perform cell resource management, exchange of state information, and the like. Accordingly, smooth exchange of control messages between the gNB-CUCP 201 and the gNB-DU 205 may be enabled.

The gNB functional split structure illustrated in FIG. 2 may enable independent operation of the control plane and the user plane in a 5G network, thereby maximizing network efficiency and flexibility.

Referring to FIGS. 1 and 2, The F1AP may be a control plane interface between the gNB-DU 103 and the gNB-CU 101, or between the gNB-DU 205 and the gNB-CUCP 201, in a gNB to which functional splitting is applied. This interface is defined in 3GPP TS38.473. Hereinafter, in FIGS. 1 and 2 of the present disclosure, only the gNB-CU is illustrated for convenience of description, however, all references to the gNB-CU may refer to either the gNB-CU or the gNB-CUCP.

According to an embodiment, the RRC, which is a control plane protocol between a user equipment and a gNB, may be handled by the gNB-CU, and a single gNB-DU may manage and operate a plurality of cells.

### [in F1AP Specification, Addition of Cell Identifier in GNBDUStatusIndication Message]

A GNBDUStatusIndication message is a message transmitted from a gNB-DU to a gNB-CU, and may be transmitted to request the gNB-CU to take appropriate action when the gNB-DU is in an overload state. In contrast, the GNBDUStatusIndication message may also be used to notify the gNB-CU that an overload state is ended and that operations based on overload-aware policies no longer need to be maintained.

The gNB-DU may manage a plurality of cells, and an overload state may occur in units of cells. For example, when it is assumed that the gNB-DU operates a first cell (cell #1) and a second cell (cell #2), the first cell (cell #1) may be in an overload state while the second cell (cell #2) may be in a normal state. In this case, the gNB-DU may transmit the GNBDUStatusIndication message to the gNB-CU to resolve the overload state of the first cell (cell #1). Upon receiving the GNBDUStatusIndication message, the gNB-CU may initiate one or more operations to resolve the overload state based on predefined policies or optimization algorithms derived in real time. Such operations may include, according to priority, handing over connected user equipments to another cell.

During this process, the gNB-CU may reduce the load of the second cell (cell #2), which is not in the overload state. This is because the GNBDUStatusIndication message does not include an identifier indicating which cell is in the overload state. When the gNB-CU makes a decision to address an issue in the second cell (cell #2) rather than the first cell (cell #1), the overload state of the first cell (cell #1) may remain unresolved.

To address this issue, the present disclosure proposes adding an identifier of a cell that is actually in an overload state to the GNBDUStatusIndication message. Table 1 illustrates a conventional message structure disclosed in 3GPP TS 38.473. Table 2 illustrates a message structure proposed in the present disclosure, in which an identifier of a cell in an actual overload state is added to solve the above-described problem.

TABLE 1

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.3.1.1 | YES | ignore |
| Type | | | | |
| Transaction | M | 9.3.1.23 | YES | reject |
| ID | | | | |
| gNB-DU | M | ENUMERATED | YES | reject |
| Overload | | (overloaded, not- | | |
| Information | | overloaded) | | |
| IAB | O | 9.3.1.227 | YES | ignore |
| Congestion | | | | |
| Indication | | | | |

TABLE 2

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | | 9.3.1.1 | YES | ignore |
| Type | | | | | |
| Transaction | M | | 9.3.1.23 | YES | reject |
| ID | | | | | |
| gNB-DU | M | | ENUMERATED | YES | reject |
| Overload | | | (overloaded, | | |
| Information | | | not- | | |
| | | | overloaded) | | |
| IAB | O | | 9.3.1.227 | YES | ignore |
| Congestion | | | | | |
| Indication | | | | | |
| NR CGI | | 0 . . . | | | |
| List | | <maxCellingNBDU> | | | |
| >NR CGI | M | | 9.3.1.12 | YES | ignore |

By applying the proposed scheme of Table 2, the gNB-DU may notify the gNB-CU of overload state information or overload-resolved state information in association with specific cells. Based on this information, the gNB-CU may perform optimized decision-making and operations for resolving system-level issues.

In detail, according to an embodiment of the present disclosure, a method for improving control message operation efficiency in a wireless communication system may include collecting cell state information including an overload state with respect to one or more cells managed by a gNB-DU, transmitting the cell state information and a cell identifier for identifying each of the cells to a gNB-CU, identifying, by the gNB-CU, a cell having the overload state by analyzing the cell identifier and the cell state information received from the gNB-DU, and performing, by the gNB-CU, optimized resource allocation and control actions with respect to the cell identified as being in the overload state.

According to an embodiment, the collecting of the cell state information by the gNB-DU may include selectively collecting only identifiers and state information for cells that are in an overload state.

According to an embodiment, the identifying of the cells in which the overload state occurs by the gNB-CU may include adjusting resource allocation according to priority so as to resolve the overload state.

### [in F1AP Specification, Addition of RRC PDU Corresponding to RRCReject Per Cell in F1SetupResponse and GNBCUConfigurationUpdate Messages]

FIG. 3 illustrates a signal flow for transferring an uplink common control channel (UL CCCH) radio resource control (RRC) message, according to one embodiment of the present disclosure.

Referring to FIG. 3, in a gNB functional split architecture, an RRC protocol (or interface) is defined between the UE and the gNB-CU, and the gNB-DU may serve only as a relay for delivery of the RRC PDU therebetween. When the gNB-DU receives the UL CCCH RRC message from the UE, the gNB-DU may need to transfer the received RRC PDU to the gNB-CU through a message procedure as illustrated in FIG. 3.

Referring to FIG. 3, the user equipment (UE) may transmit the RRC PDU (UL CCCH) message to the gNB-DU via an uplink (301). The message may include information such as a connection setup request and may be processed at the RRC layer.

The gNB-DU may transfer an InitialULRRCMessageTransfer message including the RRC PDU received from the UE to the gNB-CU (303). The InitialULRRCMessageTransfer message may include the RRC PDU of the UE, and the gNB-CU may process the connection setup with the UE based on the RRC PDU.

The UL CCCH RRC message may include at least one of an RRCSetupRequest, an RRCReestablishmentRequest, or an RRCResumeRequest. The gNB-DU may forward the received RRC PDU to the gNB-CU without identifying a type of an RRC message contained in the RRC PDU.

In some cases, the gNB-DU may not be able to support the request of the UE upon receiving the UL CCCH message. For example, when the gNB-DU reaches a maximum supported number of user equipments, the gNB-DU may not be able to support a request from the user equipment. Such a situation may also occur at the gNB-CU. When the gNB is unable to support the UE after receiving the UL CCCH message, the gNB-DU may need to transfer the RRCReject message to the UE.

However, since the gNB-DU is not capable of independently generating the RRCReject message and transmitting it to the UE, the gNB-DU is required to transmit the InitialULRRCMessage Transfer message to the gNB-CU even in the case described above. That is, since the gNB-DU may not independently generate and transmit the RRCReject message to the UE, procedures such as UE context creation (identifier) are required, resulting in inefficiency from a system perspective.

To address this issue, the present disclosure proposes adding an RRC PDU corresponding to the RRCReject to the F1SetupResponse message and the GNBCUConfigurationUpdate message. Such a message structure is illustrated in Table 3. The FlSetupResponse message and the GNBCUConfigurationUpdate message may be messages transmitted from the gNB-CU to the gNB-DU.

TABLE 3

| IE/Group | | | IE type and | Semantics | | Assigned |
|---|---|---|---|---|---|---|
| Name | Presence | Range | reference | description | Criticality | Criticality |
| Cells to be | | 0 . . . 1 | | List of cells to | YES | reject |
| Activated | | | | be activated or | | |
| List | | | | modified | | |
| >Cells to be | | 1 . . . | | | EACH | reject |
| Activated | | <maxCellingNBDU> | | | | |
| List Item | | | | | | |
| >>RRC- | O | | RRC- | Includes the | YES | ignore |
| Container- | | | Container | DL-CCCH- | | |
| RRCReject | | | 9.3.1.6 | Messagemessage | | |
| | | | | including | | |
| | | | | the | | |
| | | | | RRCReject | | |
| | | | | message, as | | |
| | | | | defined in | | |
| | | | | subclause 6.2 | | |
| | | | | of TS 38.331 | | |
| | | | | [8]. | | |

※Refer to 3GPP TS38.473 for details of RRC-Container (9.3.1.6)

According to the message structure of Table 3, when the gNB-DU receives, from the gNB-CU, the RRC PDU corresponding to the RRCReject through an F1 Setup procedure or a gNB-CU Update procedure and stores the received RRC PDU, and when the gNB-DU is unable to process reception of an uplink common control channel (UL CCCH) (e.g., when a terminal request may not be supported due to exceeding a supported number of the user terminals), the gNB-DU may directly transmit the RRCReject to the UE based on the stored RRC PDU through the F1Setup procedure or the gNB-CU Update procedure, instead of transmitting the InitialULRRCMessageTransfer to the gNB-CU, and may terminate the procedure.

In detail, according to an embodiment of the present disclosure, an operating method for improving a transmission efficiency of an RRC (radio resource control) reject message in a wireless communication system may include receiving, in advance, information required to generate the RRC reject message needed when rejecting a connection request of the UE from a gNB-CU, storing the information received in advance in a gNB-DU, receiving, by the gNB-DU, an uplink RRC packet data unit (PDU) from the UE, generating the RRC reject message based on the information stored in advance when the connection request from the UE is not accepted based on the RRC PDU, and terminating, by the gNB-DU, a connection request procedure by directly transmitting the RRC reject message to the UE without passing through the gNB-CU.

According to an embodiment, the operation of directly transmitting the RRC reject message by the gNB-DU may include reporting, to the gNB-CU, rejection details corresponding to the inability to accept the connection request of the UE.

According to an embodiment, the generated RRC reject message may be transmitted to the UE and may include a UE identifier stored in advance and a rejection cause code of the connection request.

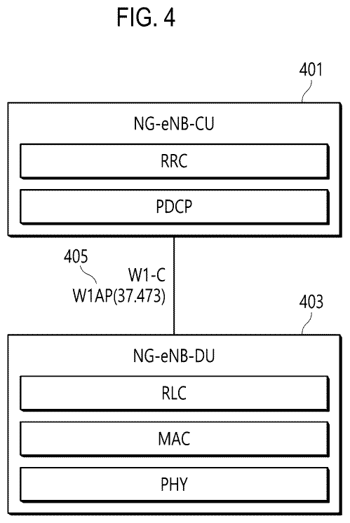

FIG. 4 illustrates another example of an NG-eNB structure according to functional splitting, according to various embodiments of the present disclosure. In detail, FIG. 4 illustrates functional splitting between an NG-eNB-CU 401 and an NG-eNB-DU 403 in an NG-eNB structure. In this structure, the NG-eNB-CU 401 and the NG-eNB-DU 403 may be connected through a W1 application protocol (W1AP).

The NG-eNB-CU 401 may include an RRC layer and a packet data convergence protocol (PDCP) layer. The RRC and PDCP layers may perform the same functions as the RRC and PDCP layers of FIG. 1.

The NG-eNB-DU 403 may include an RLC layer and a MAC layer. The RLC and MAC layers may perform the same functions as the RLC and MAC layers of FIG. 1.

A W1-C interface (W1AP) 405 is a control-plane interface between the NG-eNB-CU 401 and the NG-eNB-DU 403, and may support efficient network operation by performing cell resource management, state information exchange, and the like. The W1AP interface is defined in 3GPP TS 37.413.

The structure of FIG. 4 enables efficient management of network resources and supports high-performance network operation by separating a control plane and a user plane. While the NG-eNB-DU 403 is responsible for data transmission and physical processing, the NG-eNB-CU 401 may centrally process wireless resource control to improve network performance and flexibility. In addition, by centralizing control, network stability may be enhanced and data transmission efficiency of the user plane may be improved.

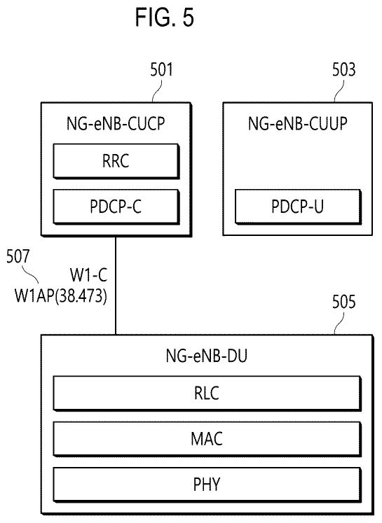

FIG. 5 illustrates another example of an NG-eNB structure according to functional splitting, according to various embodiments of the present disclosure. In detail, FIG. 5 illustrates an NG-eNB functional split structure including an NG-eNB-CUCP, an NG-eNB-CUUP, and an NG-eNB-DU. Such a structure may support efficient and flexible network operation by separating a control plane and a user plane.

An NG-eNB-CUCP 501 may include an RRC layer and a PDCP-C layer. The RRC and PDCP-C layers may perform the same functions as the RRC and PDCP-C layers of FIG. 2.

An NG-eNB-CUUP 503 may include a PDCP-U layer. The PDCP-U layer may perform the same functions as the PDCP-U layer of FIG. 2.

An NG-eNB-DU 505 may include RLC, MAC, and PHY layers. The RLC, MAC, and PHY layers may perform the same functions as the RLC, MAC, and PHY layers of FIG. 2.

A W1-C interface (W1AP) 507 may be responsible for control-plane communication between the NG-eNB-CUCP 501 and the NG-eNB-DU 505, and may perform cell resource management, state information exchange, and the like.

In the structure of FIG. 5, by separating the control plane and the user plane, control functions may be centrally processed by the NG-eNB-CUCP 501, while data processing may be independently performed by the NG-eNB-CUUP 503, thereby improving network efficiency. In addition, centralized management of control functions enables fast and efficient network operation, and performance of user data transmission may be optimized. Further, as functions are separated, network resource allocation and scaling may be flexible, thereby effectively responding to traffic increases.

Referring to FIGS. 4 and 5, the W1AP is defined in 3GPP TS 37.473 as a control-plane interface between the NG-eNB-DU 403 and the NG-eNB-CU 401, or between the NG-eNB-DU 505 and the NG-eNB-CUCP 501, in an NG-eNB to which functional splitting is applied. Hereinafter, for convenience of description, only the

NG-eNB-CU will be described, but all references to the NG-eNB-CU may refer to either the NG-eNB-CU or the NG-eNB-CUCP.

According to an embodiment, RRC, which is a control-plane protocol between the UE and the NG-eNB, is handled by the NG-eNB-CU, and a single NG-eNB-DU may manage or operate a plurality of cells.

### [In W1AP Specification, Addition of Cell Identifier in NGeNBDUStatusIndication Message]

For the same reason as adding an identifier for a cell in an actual overload state in the GNBDUStatusIndication message of Table 2, an identifier may be added to an NGeNBDUStatusIndication message in the W1AP specification, as illustrated in Table 4.

TABLE 4

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | | 9.3.1.1 | YES | ignore |
| Type | | | | | |
| Transaction | M | | 9.3.1.23 | YES | reject |
| ID | | | | | |
| ng-eNB- | M | | ENUMERATED | YES | reject |
| DU | | | (overloaded, not- | | |
| Overload | | | overloaded) | | |
| Information | | | | | |
| E-UTRAN | | 0 . . . <maxCellinng- | | | |
| CGI List | | eNBDU> | | | |
| >E- | M | | 9.3.1.12 | YES | ignore |
| UTRAN | | | | | |
| CGI | | | | | |

In detail, according to an embodiment of the present disclosure, a method for improving control message operation efficiency in a wireless communication system includes collecting cell state information including an overload state with respect to one or more cells managed by an NG-eNB-DU, transmitting the cell state information and a cell identifier for identifying each of the cells to the NG-eNB-DU, identifying, by an NG-eNB-CU, a cell having the overload state by analyzing the cell identifier and the cell state information received from the NG-eNB-DU, and performing, by the NG-eNB-CU, optimized resource allocation and control actions with respect to the cell identified as being in the overload state.

According to an embodiment, the collecting of the cell state information by the NG-eNB-DU may include selectively collecting only identifiers and state information of cells identified as being in the overload state.

According to an embodiment, the identifying of the cells in which the overload state occurs by the NG-eNB-CU may include adjusting resource allocation according to priority to mitigate the overload state.

### [In W1AP Specification, Addition of an RRC PDU Corresponding to an RRCConnectionReject for Each Cell in W1SetupResponse and NGeNBCUConfiguration Update Messages]

For the same reason as adding an RRC PDU corresponding to an RRCReject to the F1SetupResponse and GNBCUConfigurationUpdate messages of Table 3, the RRC PDU may be added to the W2SetupResponse and NGeNBCUConfigurationUpdate messages in the W1AP specification, as illustrated in Table 5. The F1SetupResponse message and the GNBCUConfigurationUpdate message may be messages transmitted from the gNB-CU to the gNB-DU.

TABLE 5

| IE/Group | | | IE type and | Semantics | | Assigned |
|---|---|---|---|---|---|---|
| Name | Presence | Range | reference | description | Criticality | Criticality |
| Cells to be | | 0 . . . 1 | | List of cells | YES | reject |
| Activated List | | | | to be | | |
| | | | | activated or | | |
| | | | | modified | | |
| >Cells to be | | 1 . . . | | | EACH | reject |
| Activated List | | <maxCellinng- | | | | |
| Item | | eNBDU> | | | | |
| >>RRC- | O | | RRC-Container | Includes the | YES | ignore |
| Container- | | | 9.3.1.6 | DL-CCCH- | | |
| RRCConnectionReject | | | | Messagemessage | | |
| | | | | including | | |
| | | | | the | | |
| | | | | RRCConnectionReject | | |
| | | | | message, as | | |
| | | | | defined in | | |
| | | | | subclause | | |
| | | | | 6.2 of TS | | |
| | | | | 36.331 [2]. | | |

In detail, according to one embodiment of the present disclosure, an operating method for improving a transmission efficiency of an RRC (radio resource control) reject message in a wireless communication system may include receiving, in advance, information required to generate the RRC reject message needed when rejecting a connection request of a user equipment (UE) from an NG-eNB-CU, storing the information received in advance in an NG-eNB-DU, receiving, by the NG-eNB-DU, an uplink RRC packet data unit (PDU) from the UE, generating the RRC reject message based on the information stored in advance when the connection request from the UE is not accepted based on the RRC PDU, and terminating, by the NG-eNB-DU, a connection request procedure by directly transmitting the RRC reject message to the UE without passing through the NG-eNB-CU.

According to an embodiment, the operation of directly transmitting the RRC reject message by the NG-eNB-DU may include reporting, to the NG-eNB-CU, rejection details corresponding to the inability to accept the connection request of the UE.

According to an embodiment, the generated RRC reject message may be transmitted to the UE and may include a UE identifier stored in advance and a rejection cause code of the connection request.

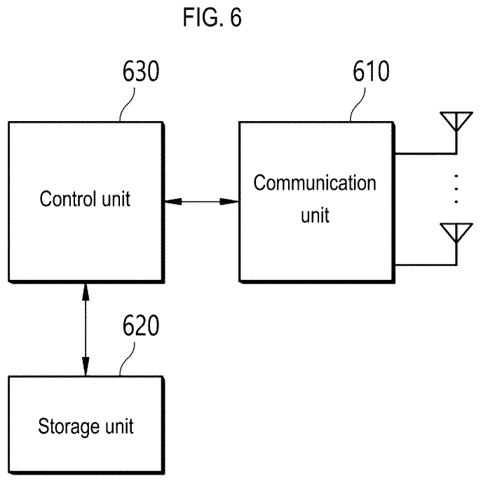

FIG. 6 illustrates a configuration of a user equipment (UE) in a wireless communication system, according to various embodiments of the present disclosure.

The configuration illustrated in FIG. 6 may be understood as a configuration of the UE. Hereinafter, the terms “unit,” “module,” or the like refer to a unit for processing at least one function or operation, and may be implemented as hardware, software, or a combination of hardware and software.

Referring to FIG. 6, the UE may include a communication unit 610, a storage unit 620, and a control unit 630.

The communication unit 610 may perform functions for transmitting and receiving signals through a wireless channel. For example, the communication unit 610 may perform conversion functions between baseband signals and bit streams according to a physical layer specification of a communication system. For example, during data transmission, the communication unit 610 may generate complex symbols by encoding and modulating a transmission bit stream. During data reception, the communication unit 610 may restore a received bit stream by demodulating and decoding a baseband signal. In addition, the communication unit 610 may up-convert a baseband signal to a radio frequency (RF) band signal and transmit the RF band signal through an antenna, and may down-convert an RF band signal received through the antenna to a baseband signal. For example, the communication unit 610 may include a transmission filter, a reception filter, an amplifier, a mixer, an oscillator, a digital-to-analog converter (DAC), and an analog-to-digital converter (ADC).

In addition, the communication unit 610 may include a plurality of transmission and reception paths. Further, the communication unit 610 may include at least one antenna array including a plurality of antenna elements. From a hardware perspective, the communication unit 610 may be configured as a digital circuit and an analog circuit (e.g., a radio frequency integrated circuit (RFIC)). In this case, the digital circuit and the analog circuit may be implemented in a single package. In addition, the communication unit 610 may include a plurality of RF chains. Further, the communication unit 610 may perform beamforming.

As described above, the communication unit 610 transmits and receives signals. Accordingly, all or a part of the communication unit 610 may be referred to as a “transmitter”, a “receiver”, or a “transceiver”. In the following description, transmission and reception performed through a wireless channel may be understood as including the processing performed by the communication unit 610 as described above.

The storage unit 620 may store a basic program for operation of the UE, application programs, and data such as configuration information. The storage unit 620 may be configured as a volatile memory, a non-volatile memory, or a combination of the volatile memory and the non-volatile memory. The storage unit 620 may provide stored data in response to a request from the control unit 630.

The control unit 630 may control overall operations of the UE. For example, the control unit 630 may transmit and receive signals through the communication unit 610. In addition, the control unit 630 may write data to and read data from the storage unit 620. The control unit 630 may perform functions of a protocol stack required by a communication standard. To this end, the control unit 630 may include at least one processor or microprocessor, or may be implemented as a part of a processor. In addition, a part of the communication unit 610 and the control unit 630 may be referred to as a communication processor (CP).

According to various embodiments, the control unit 630 may allow the UE to perform operations according to various embodiments of the present disclosure described below.

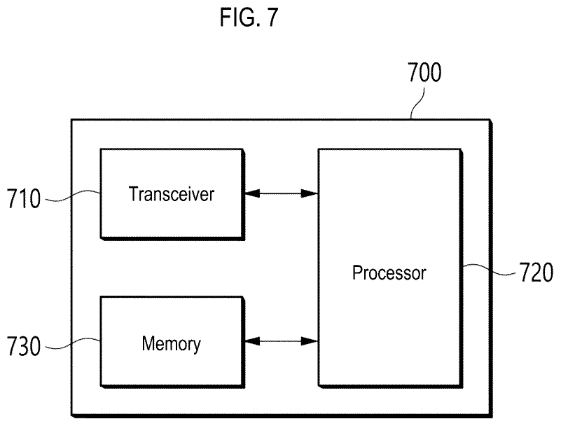

FIG. 7 illustrates a configuration of a gNB including a central unit (CU) and a distributed unit (DU), according to various embodiments of the present disclosure.

Referring to FIG. 7, a gNB 700 may include a transceiver 710, a processor 720, and a memory 730. According to the communication methods of the gNB 700 described above, the transceiver 710, the processor 720, and the memory 730 of the gNB 700 may operate. However, the components of the gNB 700 may not be limited to the above-described examples. For example, the gNB 700 may include more components or fewer components than those described above. In an embodiment, the transceiver 710, the processor 720, and the memory 730 may be implemented in the form of a single chip. In addition, the processor 720 may include one or more processors.

The transceiver 710 collectively refers to a receiver of the gNB 700 and a transmitter of the gNB 700, and may transmit and receive signals to and from a user equipment or a network entity. Signals transmitted to and received from the user equipment or the network entity may include control information and data.

Further, the transceiver 710 may perform functions for transmitting and receiving signals through a wireless channel. For example, the transceiver 710 may receive signals through the wireless channel and output the received signals to the processor 720, and may transmit signals output from the processor 720 through the wireless channel.

The memory 730 may store programs and data required for operation of the gNB 700. In addition, the memory 730 may store control information or data included in signals obtained at a base station. The memory 730 may be configured using a storage medium such as a read-only memory (ROM), a random access memory

(RAM), a hard disk, a CD-ROM, and a DVD, or a combination of storage media. Alternatively, the memory 730 may not be separately provided and may be implemented as part of the processor 720. The memory 730 may be configured as a volatile memory, a non-volatile memory, or a combination of the volatile memory and the non-volatile memory. The memory 730 may provide stored data in response to a request from the processor 720.

The processor 720 may control a series of processes such that the gNB 700 operates according to the embodiments of the present disclosure described above. For example, the processor 720 may receive control signals and data signals through the transceiver 710 and may process the received control signals and the received data signals. The processor 720 may transmit the processed control signals and the processed data signals through the transceiver 710. In addition, the processor 720 may write data to or read data from the memory 730. The processor 720 may perform functions of a protocol stack required by a communication standard. To this end, the processor 720 may include at least one processor or microprocessor. In an embodiment, a portion of the transceiver 710 or the processor 720 may be referred to as a communication processor (CP). In this case, the processor 720 may be a general-purpose processor such as a CPU, an application processor (AP), or a digital signal processor (DSP), a graphics-dedicated processor such as a GPU or a vision processing unit (VPU), or an artificial intelligence (AI)-dedicated processor such as a neural processing unit (NPU). For example, when one or more processors are AI-dedicated processors, the AI-dedicated processors may be designed with a hardware architecture specialized for processing a specific AI model. The processor 720 may be controlled to process input data derived from the received control signals and the received data signals, according to an AI model.

Methods according to the embodiments described in the claims or the specification of the present disclosure may be implemented in the form of hardware, software, or a combination of hardware and software.

When implemented in software, a computer-readable storage medium storing one or more programs (software modules) may be provided. The one or more programs stored in the computer-readable storage medium are configured to be executable by one or more processors in an electronic device. The one or more programs include instructions that cause the electronic device to execute the methods according to the claims of the present disclosure or the embodiments described in the specification.

Such programs (software modules, software) may be stored in a random access memory (RAM), a non-volatile memory including flash memory, a read-only memory (ROM), an electrically erasable programmable read-only memory (EEPROM), a magnetic disk storage device, a compact disc read-only memory (CD-ROM), digital versatile discs (DVDs), other types of optical storage devices, magnetic cassettes, or a memory configured as a combination of some or all thereof. In addition, a plurality of such memories may be provided.

Further, the programs may be stored in an attachable storage device that is accessible through a communication network such as the Internet, an intranet, a local area network (LAN), a wide area network (WAN), or a storage area network (SAN), or a combination thereof. Such a storage device may be connected to an apparatus performing embodiments of the present disclosure through an external port. In addition, a separate storage device on a communication network may be connected to the apparatus performing embodiments of the present disclosure.

According to an embodiment of the present disclosure, the apparatus and the method improve efficiency of control message operation, thereby enabling optimized network resource management and enhanced system performance.

The effects that may be obtained from the present disclosure are not limited to the effects mentioned above, and other effects not described herein may be more clearly understood from the above detailed description by persons skilled in the art.

In the foregoing detailed embodiments of the present disclosure, components included in the present disclosure are expressed in singular or plural form according to the specific embodiments presented. However, the singular or plural expressions are selected appropriately for convenience of description, and the present disclosure is not limited to components expressed in the singular or plural form. Accordingly, a component expressed in the plural form may be configured as a single component, and a component expressed in the singular form may be configured as a plurality of components.

While the present disclosure has been described in detail with reference to particular embodiments, it will be apparent to those skilled in the art that various changes and modifications may be made without departing from the scope of the present disclosure. Therefore, the scope of the present disclosure should not be limited to the above-described embodiments and should be defined by the claims described below as well as those equivalents to the claims of this disclosure.

What is claimed is:

1. An operating method for improving a transmission efficiency of an RRC (radio resource control) reject message in a wireless communication system, the method comprising:
receiving, in advance, information required to generate the RRC reject message needed when rejecting a connection request of a user equipment (UE) from a gNB-CU or an NG-eNB-CU;
storing the information received in advance in a gNB-DU or an NG-eNB-DU;
receiving, by the gNB-DU or the NG-eNB-DU, an uplink RRC packet data unit (PDU) from the UE;
generating the RRC reject message based on the information stored in advance when the connection request from the UE is not accepted based on the RRC PDU; and
terminating, by the gNB-DU or the NG-eNB-DU, a connection request procedure by directly transmitting the RRC reject message to the UE without passing through the gNB-CU or the NG-eNB-CU.

2. The method of claim 1, wherein the directly transmitting, by the gNB-DU or the NG-eNB-DU, of the RRC reject message includes reporting rejection details corresponding to an inability to accept the connection request of the UE to the gNB-CU or the NG-eNB-CU.

3. The method of claim 1, wherein the generated RRC reject message is transmitted to the UE and includes a user equipment identifier stored in advance and a rejection cause code corresponding to the connection request.

4. A method for improving control message operation efficiency in a wireless communication system, the method comprising:
collecting cell state information including an overload state with respect to one or more cells managed by a gNB-DU or an NG-eNB-DU;
transmitting the cell state information and a cell identifier for identifying each of the cells to a gNB-CU or an NG-eNB-CU;
identifying, by the gNB-CU or the NG-eNB-CU, a cell having the overload state by analyzing the cell identifier and the cell state information received from the gNB-DU or the NG-eNB-DU; and
performing, by the gNB-CU or the NG-eNB-CU, optimized resource allocation and control actions with respect to the cell identified as being in the overload state.

5. The method of claim 4, wherein the collecting, by the gNB-DU or the NG-eNB-DU, of the cell state information includes selectively collecting only the cell identifier of the cell having the overload state and the state information.

6. The method of claim 4, wherein the identifying, by the gNB-CU or the NG-eNB-CU, of the cell in which the overload state occurs includes adjusting the resource allocation based on a priority to alleviate the overload state.

7. An apparatus for improving transmission efficiency of an RRC (radio resource control) reject message in a wireless communication system, comprising:
a transceiver; and
a processor operatively connected to the transceiver, and
wherein the processor is configured to:
receive, in advance, information required to generate the RRC reject message needed when rejecting a connection request of a user equipment (UE) from a gNB-CU or an NG-eNB-CU;
store the information received in advance in a gNB-DU or an NG-eNB-DU;
cause the gNB-DU or the NG-eNB-DU to receive an uplink RRC packet data unit (PDU) from the UE;
generate the RRC reject message based on the information stored in advance when the connection request of the UE is not accepted based on the RRC PDU; and
cause the gNB-DU or the NG-eNB-DU to directly transmit the RRC reject message to the UE without passing through the gNB-CU or the NG-eNB-CU, to terminate a connection request procedure.

8. The apparatus of claim 7, wherein the processor is configured to cause the gNB-DU or the NG-eNB-DU to report rejection details corresponding to an inability to accept the connection request of the UE to the gNB-CU or the NG-eNB-CU to directly transmit the RRC reject message.

9. The apparatus of claim 7, wherein the generated RRC reject message is transmitted to the UE and includes a user equipment identifier stored in advance and a rejection cause code corresponding to the connection request.

10. An apparatus for improving control message operation efficiency in a wireless communication system, comprising:
a transceiver; and
a processor operatively connected to the transceiver, and wherein the processor is configured to:
collect cell state information including an overload state with respect to one or more cells managed by a gNB-DU or an NG-eNB-DU;
transmit the cell state information and a cell identifier identifying each of the cells to a gNB-CU or an NG-eNB-CU;
cause the gNB-CU or the NG-eNB-CU to analyze the cell identifier and the cell state information received from the gNB-DU or the NG-eNB-DU, to identify a cell having the overload state; and
cause the gNB-CU or the NG-eNB-CU to perform optimized resource allocation and control actions with respect to the cell identified as being in the overload state.

11. The apparatus of claim 10, wherein the processor is configured to cause the gNB-DU or the NG-eNB-DU to selectively collect only the cell identifier of the cell having the overload state and the state information, to collect the cell state information.

12. The apparatus of claim 10, wherein the processor is configured to cause the gNB-CU or the NG-eNB-CU to identify the cell in which the overload state occurs, to adjust the resource allocation based on a priority to alleviate the overload state.
